(19) United States
(12) Patent Application Publication
(10) Pub. No.: US 2008/0181685 A1
(43) Pub. Date: Jul. 31, 2008

(54) FIXING DEVICE AND FIXING METHOD

(75) Inventor: Katsuya Shimatsu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/018,465

(22) Filed: Jan. 23, 2008

(30) Foreign Application Priority Data
Jan. 31, 2007 (JP) 2007-021251

(51) Int. Cl. G03G 15/20

(52) U.S. Cl. 399/324

(57) ABSTRACT

A fixing device comprising a fixing unit comprising a heat source for fixing a toner image on a sheet in a state of being out of contact with the sheet, and a contact prevention unit preventing contact of the fixing unit and the sheet.

### CROSS-REFERENCE TO RELATED APPLICATIONS

This application is based on and claims priority under 35 USC 119 from Japanese Patent Application No. 2007-021251 filed Jan. 31, 2007.

### BACKGROUND OF THE INVENTION

1. Technical Field

The present invention relates to a fixing device and fixing method.

2. Related Art

Conventionally, as an image forming device of an electrophotographic method, there is an image forming device using a flash fixing method for fixing a toner on a recording media by using a flash lump.

In the above-described image forming device, a fan is provided between a developing unit and a fixing unit.

### SUMMARY

A fixing device of a first aspect of the present invention has a fixing unit provided with a heat source for fixing a toner image on sheet in a state out of contact with the sheet, and a contact prevention unit preventing contact of the fixing unit and the sheet.

### BRIEF DESCRIPTION OF THE DRAWINGS

Embodiments of the present invention will be described in detail based on the following figures, wherein:

FIG. 1 is a cross-sectional view of an image forming device according to a first exemplary embodiment of the present invention;

FIG. 2A is a cross sectional view of a fixing device according to the first exemplary embodiment of the invention, and FIG. 2B is a front view of a fixing unit according to the first exemplary embodiment of the invention;

FIGS. 3A and 3B are schematic diagrams showing a recording paper jam detection method according to the first exemplary embodiment of the invention;

FIG. 4 is a cross-sectional view showing a state during recording paper jam in the fixing device according to the first exemplary embodiment of the invention;

FIGS. 5A and 5B are cross-sectional views of the fixing device according to a second exemplary embodiment of the invention;

FIGS. 6A to 6C are cross-sectional views of the fixing device according to a third exemplary embodiment of the invention; and

FIGS. 7A and 7B are perspective views of the fixing device according to a fourth exemplary embodiment of the invention.

### DESCRIPTION

A first exemplary embodiment of an image forming device of the invention will be described with reference to the drawings.

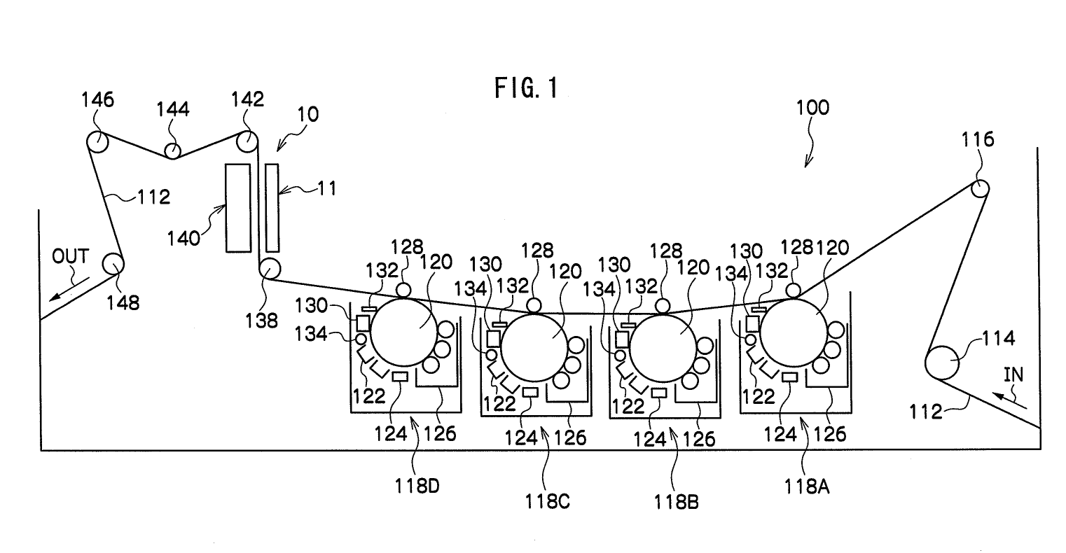

As shown in FIG. 1, an image forming device 100 for performing flash fixing for fixing by an irradiation heat of a xenon lump or the like after forming an image is provided.

The image forming device 100 forms the image on recording paper 112, formed of continuous form paper capable of being cut, as one example of the paper.

The recording paper 112 inserted into the image forming device 100 from an arrow IN direction is wrapped around wrapping rollers 114 and 116, and is fed on a feeding path formed so as to cross an inner portion of the image forming device 100 at a constant speed.

On a lower side of the feeding path of the recording paper 112, image forming units 118A, 118B, 118C and 118D for forming toner images of C (cyan), M (magenta), Y (yellow) and K (black), respectively, are arranged along the feeding path at substantially regular intervals therebetween.

Each of the image forming units 118A to 118D is provided with a photosensitive drum 120, which has the same configuration except the color of the toner image to be formed, and is arranged such that an axis line thereof is orthogonal to a feeding direction of the recording paper 112.

A charger 122 for charging the photosensitive drum 120 is provided around the photosensitive drum 120. An exposure device 124 for irradiating a charged photosensitive drum 120 with an LED light to form an electrostatic latent image is provided on a downstream side of the charger 122 in a rotation direction of the photosensitive drum 120.

A developing device 126 for forming the toner image by supplying a toner of a predetermined color to the electrostatic latent image on the photosensitive drum 120 is provided on a downstream side of the exposure device 124.

A transferring device 128 arranged so as to be opposed to the photosensitive drum 120 with the feeding path of the recording paper 112 interposed therebetween for transferring the toner image on the recording paper 112 is provided on a downstream side of the developing device 126.

A discharger 130 for discharging a surface of the photosensitive drum 120, a cleaner blade 132 for removing residual toner on the surface of the photosensitive drum 120, and a cleaner brush 134 are arranged on a downstream side of the transferring device 128.

Herein, when printing in color, the image forming units 118A to 118D form the toner images of which colors are different to one another on the peripheral surfaces of the photosensitive drums 120 by the chargers 122, the exposure devices 124, and the developing devices 126, and thereafter, transfer the toner images on the recording paper 112 by the transferring devices 128.

In a series of process of charge, exposure (electrostatic latent image forming), develop (toner image forming) and transfer in the image forming units 118A to 118D, an execution timing thereof is controlled such that the toner images formed at the image forming units 118A to 118D are overlapped to one another on the recording paper 112. Thereby, a full-color toner image is formed on the recording paper 112.

Also, when printing monochrome image, the image forming unit 118D for black is driven to form a black toner image on the peripheral surface of the photosensitive drum 120 by the charger 122, the exposure device 124 and the developing device 126, and thereafter, by transferring the toner image on the recording paper 112 by the transferring unit 128, the black toner image is formed on the recording paper 112.

In the feeding path of the recording paper 112, the feeding direction is changed to a substantially vertical direction by a wrapping roller 138 on a downstream side of positions of the image forming units 118A to 118D.

In a section between the wrapping roller 138 and a wrapping roller 142 at a downstream side of the wrapping roller 138, the recording paper 112 is fed upward in the substantially vertical direction. A fixing device 10 is arranged on the feeding path between the wrapping rollers 138 and 142.

The fixing device 10 is provided with a flash fixing unit 140 as one example of a fixing unit and an air intake unit 11 as one example of an air intake part.

A tension roller 144 is provided at a downstream side of the wrapping roller 142.

Detection part such as a pressure sensor or an optical position sensor not shown is provided on the tension roller 144. Also, a portion of an outer peripheral side surface of the tension roller 144 abuts the recording paper 112, and the tension roller 144 is energized in a direction to press the recording paper 112 to a lower side by using a spring or the like.

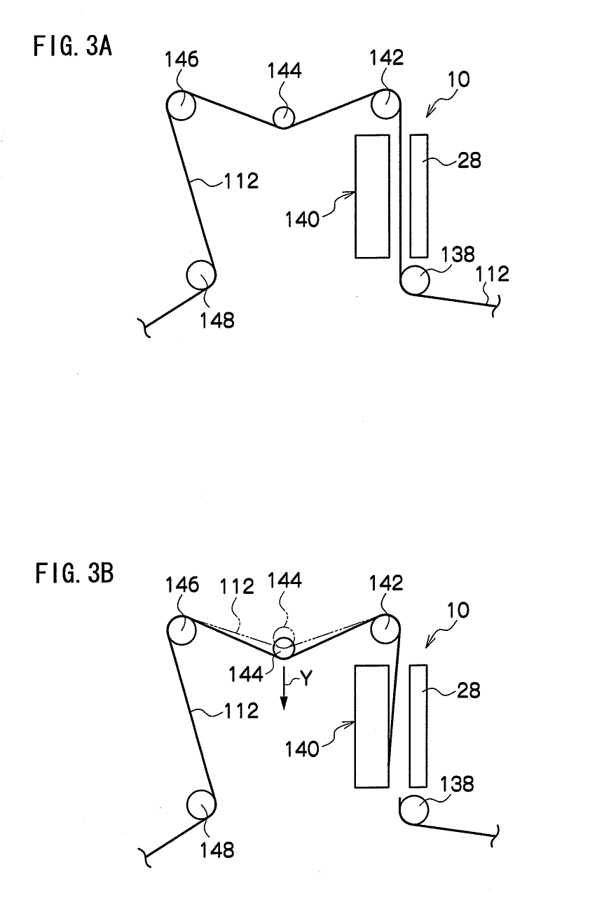

Herein, as shown in FIG. 3A, at the time of ordinary use of the image forming device 100, the recording paper 112 is tightened with a predetermined tension, and the tension roller 144 is at a position at which the above-described energizing force and the tension of the recording paper 112 are balanced.

On the other hand, as shown in FIG. 3B, when a jam occurs and the recording paper 112 is cut, the tension of the recording paper 112 is weakened, so that the position of the tension roller 144 lowers from a general position (two-dot chain line) to a lower position (solid line) by the energizing force.

By detecting this change in position of the tension roller 144 by the above-described pressure sensor or optical position sensor, the jam of the recording paper 112 is detected.

Also, as shown in FIG. 1, the wrapping rollers 146 and 148 are sequentially arranged at a downstream side of the tension roller 144, and it is configured that the recording paper 112 on which the toner image is fixed is guided to the wrapping rollers 146 and 148 and is discharged outside of the image forming device 100.

Next, the fixing device 10 will be described.

The fixing device 10 is provided with the flash fixing unit 140 and the air intake unit 11 as described above.

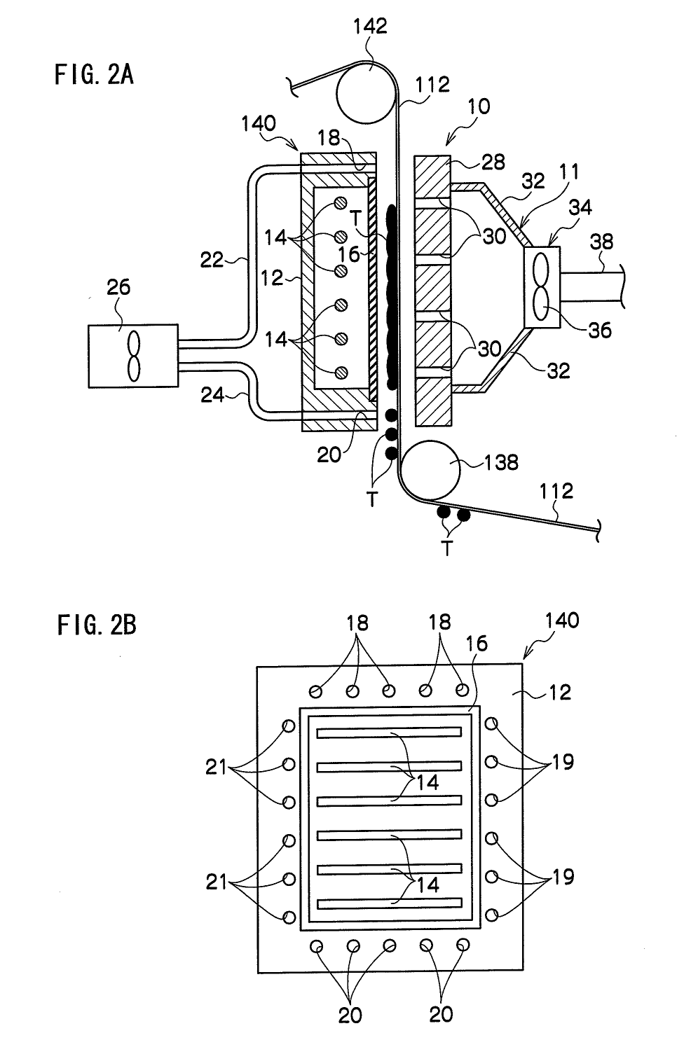

As shown in FIG. 2, the flash fixing unit 140 has a housing 12 in a box-shape one planar surface of which is opened, and is provided with flash lumps 14 in the housing 12, as one example of six heat sources emitting the flash light.

The flash lamps 14 emits the flash light by a voltage supplied from a power supply not shown to fuse a toner T on the recording paper 112 by energy of the flash light, thereby fixing the toner image transferred on the recording paper 112.

A cover glass 16 is arranged on a front surface side of the flash lamps 14 and the feeding path side of the recording paper 112.

The cover glass 16 as one example of a protective glass is fixed to the housing 12 by adhesion to prevent intrusion of dust or the like into the flash fixing unit 140, and prevents the recording paper 112 and the flash lamps 14 from contacting each other.

Also, plural penetrating air-through holes 18, 19, 20 and 21 are formed in the housing 12 so as to enclose the flash lamps 14. One end of each of stainless pipes 22 and 24 are connected to the air-through holes 18, 19, 20 and 21, and other end of each of the pipes are connected to a fan 26.

The fan 26 as one example of an air sending part is driven by power supplied by power supply means not shown to supply air to the pipes 22 and 24.

Thereby, when the power is supplied to the fan 26 by the power supply means, air is supplied to the pipes 22 and 24, and air is sent from the air-through holes 18 to 21 toward the recording paper 112.

The air sending part is formed from the fan 26, the pipes 22 and 24, and the air-through holes 18 to 21.

The air intake unit 11 is arranged on a position opposed to the front surface of the flash fixing unit 140 with the feeding path of the recording paper 112 interposed therebetween.

The air intake unit 11 as one example of a contact prevention unit has a side plate 28, a duct 32, an air intake device 34 and a pipe 38.

The side plate 28 is fixed so as to be apart from the recording paper 112 by a predetermined distance, and plural air intake holes 30 penetrating toward the recording paper 112, are formed therein. Also, the duct 32 is provided on a surface opposite to the recording paper 112 of the side plate 28 so as to cover the air intake holes 30.

An opening is formed on one end portion of the duct 32, and the air intake device 34 is fixed to the opening by a screw, an adhesive or the like. Also, an inclined surface to make an air flow be stable during air intake is formed in the duct 32.

The air intake device 34 is provided with a fan 36 rotating by driving means such as a motor or the like not shown inside thereof. In addition, a pipe 38 for discharging intaken air outside of the image forming device 100 is connected to the air intake device 34.

Thereby, when the air intake device 34 is driven, the fan 36 rotates and intakes air through the air intake holes 30, and the intaken air is discharged from the duct 32 through the fan 36 to the pipe 38.

Note that, the contact prevention unit of this exemplary embodiment is formed of the air sending part from the fan 26 to the air through holes 18 to 21, and the air intake unit 11.

Also, it is configured that when the jam is detected, a jam detection signal is sent to a driving unit not shown and the driving unit drives the fan 26 and the air intake device 34.

Next, function of the first exemplary embodiment of the invention will be described.

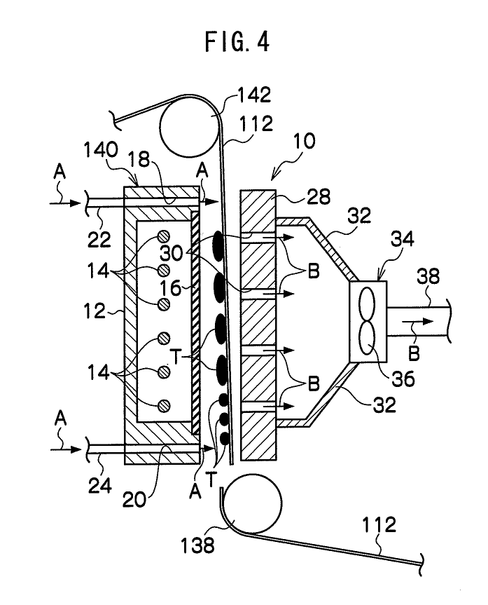

As shown in FIGS. 3 and 4, when the jam of the recording paper 112 occurs during operation of the image forming device 100 (refer to FIG. 1) and the recording paper 112 is cut, the position of the tension roller 144 lowers and the jam is detected by the above-described sensor.

The fan 26 (refer to FIG. 2) and the air intake device 34 are driven by the jam detection signal.

Air sent from an arrow A direction is blown on a recording surface side of the recording paper 112, and a rear surface side of the recording paper 112 is sucked to a side plate 28 side by the air intaken in an arrow B direction.

Thereby, the recording paper 112 is kept away from the cover glass 16 of the flash fixing unit 140.

Next, a second exemplary embodiment of the fixing device and the image forming device of the invention will be described with reference to the drawings.

The same reference numeral as that in the above-described first exemplary embodiment is given to the basically same component as that in the above-described first exemplary embodiment, and the description thereof is omitted.

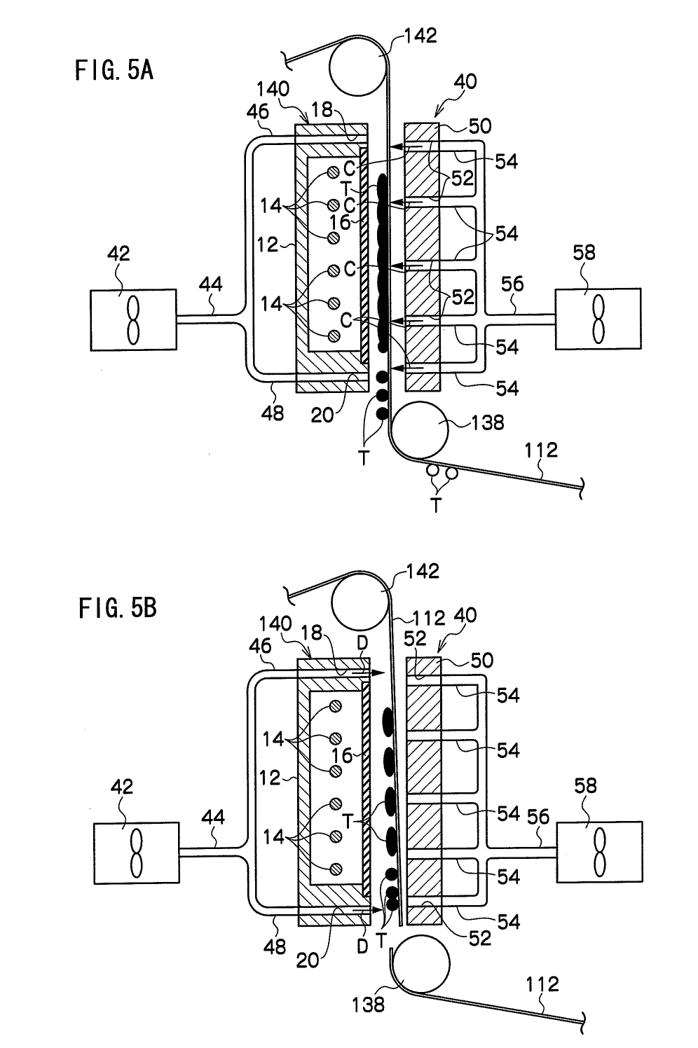

As shown in FIGS. 5A and 5B, one end of each of stainless pipes 46 and 48 are connected to the air-through holes 18 and 20 of the flash fixing unit 140, respectively, and the pipes 46 and 48 are connected to a pipe 44 by a three-way joint not shown and inner sides thereof are communicated to one another. The other end of the pipe 44 is connected to a first fan 42.

It is configured that the first fan 42 is driven by the power supplied from power supplying unit not shown, and supplies air to the pipe 44.

Thereby, it is configured that when the first fan 42 is driven by the power supplied from the power supplying unit, air is supplied through the pipe 44 to the pipes 46 and 48, and air is sent from the air-through holes 18 to 21 toward the recording paper 112 in an arrow D direction.

On the other hand, an air sending unit 40 is arranged on a position opposed to the front surface of the flash fixing unit 140 with the feeding path of the recording paper 112 interposed therebetween.

The air sending unit 40 as one example of a reverse air sending part has a side plate 50 seperated from the recording paper 112 with a predetermined distance therebetween, a pipe 54, and a second fan 58.

A plurality of air-through holes 52 penetrating toward the recording paper 112 are formed in the side plate 50. A plurality of pipes 54 are arranged on a surface opposite to the recording paper 112 on the side plate 50, and the air-through holes 52 and the pipes 54 are connected and fixed.

The other end of the pipe 54 is connected to one pipe 56 by a joint not shown, and the other end of the pipe 56 is connected to a second fan 58.

It is configured that the second fan 58 is driven by the power supplied from power supplying unit not shown to supply air to the pipe 56.

Thereby, when the second fan 58 is driven, air is supplied through the pipe 56 to a plurality of pipes 54, and air is sent from a plurality of air-through holes 52 toward the rear surface of the recording paper 112 in an arrow C direction.

Next, function of the second exemplary embodiment of the invention will be described.

In the image forming device 100 (refer to FIG. 1), the second fan 58 is driven during fixation on the recording paper 112. Air supplied from the second fan 58 is sent through the pipes 56 and 54 in the arrow C direction.

Thereby, the recording paper 112 gets close to a flash fixing unit 140 side by air sent from the arrow C direction, and heat by light emission of the flash lumps 14 is transmitted to the toner T on the recording paper 112.

On the other hand, when the recording paper 112 is cut during the jam of the recording paper 112, the jam detection device in the above-described tension roller 144 (refer to FIG. 3) activates to drive the first fan 42. Air sent from the first fan 42 is sent from the pipe 44 through the pipe 46 or 48 in the arrow D direction.

Thereby, the recording paper 112 is kept apart from the cover glass 16.

Next, a third exemplary embodiment of the fixing device and the image forming device of the invention will be described with reference to the drawings.

The same reference numeral as that in the above-described first exemplary embodiment is given to the basically same component as that in the above-described first exemplary embodiment, and the description thereof is omitted.

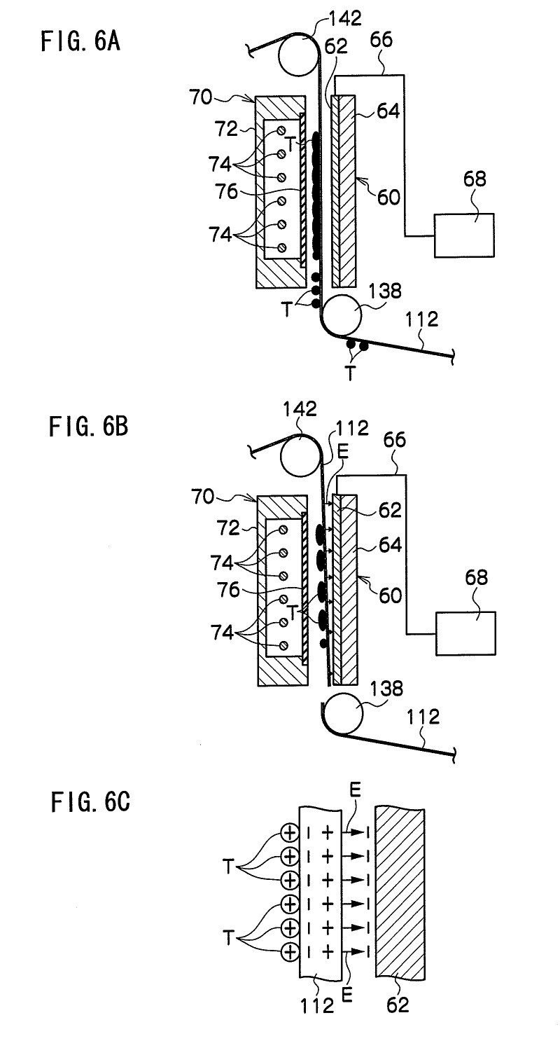

As shown in FIGS. 6A to 6C, a flash fixing unit 70 is provided in the image forming device 100.

In the flash fixing unit 70 as one example of the fixing unit, flash lumps 74 as one example of six heat sources are arranged in a housing 72 in a box-shape having an opening on one side, and the opening is covered with the cover glass 76.

An electrostatic absorption device 60 is arranged at a position opposed to the cover glass 76 with a predetermined distance therebetween.

The electrostatic absorption device 60 as one example of electrostatic force generation part is configured such that a plastic composite plate 62 in which an electrode not shown is included is arranged on a base 64 for fixed positioning.

One end of a cable 66 for supplying direct current voltage is connected to the electrode in the plastic composite plate 62. The other end of the cable 66 is connected to a power supply 68 for outputting the direct current voltage.

A charged polar character of the toner T in this exemplary embodiment is set to positive.

Next, function of the third exemplary embodiment of the invention will be described.

As shown in FIG. 6A, during fixation on the recording paper 112, the direct current voltage is not output from the power supply 68 to the electrode inside the plastic composite plate 62, and the recording paper 112 passes between the flash fixing unit 70 and the electrostatic absorption device 60 without being absorbed.

Next, as shown in FIG. 6B, when the recording paper 112 is cut during the jam of the recording paper 112, the jam detection device in the above-described tension roller 144 (refer to FIG. 3) activates to drive the power supply 68.

By the drive of the power supply 68, the direct current voltage is supplied to the electrode in the plastic composite plate 62, and a surface of the plastic composite plate 62 charges negatively.

Herein, as shown in FIG. 6C, the polar character of the toner T after transferring is positive, and the polar character on a surface side of the recording paper 112, which contacts the toner T, is negative.

In addition, the polar character of the rear surface side of the recording paper 112, which does not contact the toner T, is positive.

Therefore, the recording paper 112 is drawn in an arrow E direction by a Coulomb attraction between a negative charge on the surface of the plastic composite plate 62 and a positive charge on the rear surface side of the recording paper 112.

Thereby, the recording paper 112 is kept apart from the cover glass 76.

Next, a fourth exemplary embodiment of the fixing device and the image forming device of the invention will be described with reference to the drawings.

The same reference numeral as that of the above-described first exemplary embodiment is given to the basically same component as that of the above-described first exemplary embodiment, and the description thereof is omitted.

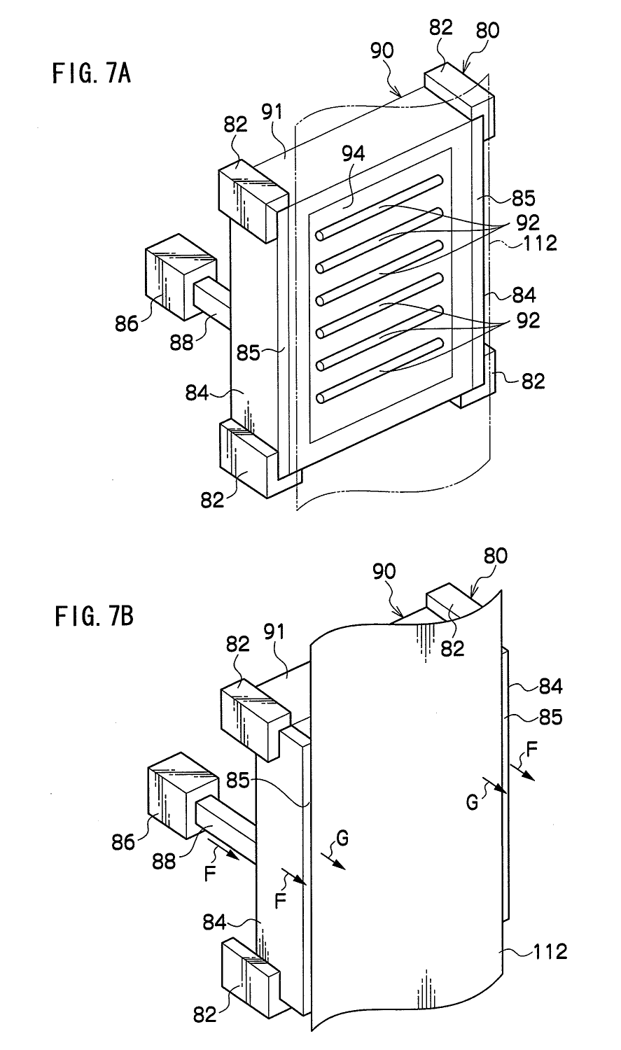

As shown in FIG. 7A, a flash fixing unit 90 is provided inside the image forming device 100 (refer to FIG. 1).

In the flash fixing unit 90 as one example of the fixing unit, flash lumps 92 as one example of six heat sources are arranged in a housing 91 in a box-shape having an opening on one side, and the opening is covered with a cover glass 94.

Moving units 80 are provided at positions next to right and left side surfaces of the flash fixing unit 90.

The moving unit 80 is composed of guide rails 82, a moving plate 84, a shaft 88, and a solenoid 86.

A pair of the guide rails 82 set at an upper and lower positions are provided adjacent to the right and left side surfaces of the flash fixing unit 90 respectively, and the moving plate 84 is inserted between the upper and lower pair of guide rails 82.

The moving plate 84 has an abutment surface 85 abutting the recording paper 112 when detecting the jam of the recording paper 112, and one end of the shaft 88 is fixed to a side surface opposite to the abutment surface 85 of the moving plate 84 by fitting or adhesion. Also, the other end of the shaft 88 is fixed to an axis core not shown of the solenoid 86.

In the solenoid 86, a magnetic field generates by electric current supplied from a power supply not shown and the axis core moves in a linear line. Thereby, when the electric current is supplied to the solenoid 86, the shaft 88 moves in a linear line, thereby the transfer plate 84 is movable along the guide rails 82.

Next, function of the fourth exemplary embodiment of the invention will be described.

During the jam of the recording paper 112, the jam detection device in the above-described tension roller 144 (refer to FIG. 3) activates, and the electric current is supplied from the power supply not shown to the solenoid 86.

When the electric current is supplied to the solenoid 86, the shaft 88 moves in an arrow F direction, and the moving plate 84 moves along the guide rails 82 in the arrow F direction.

The abutment surface 85 of the transfer plate 84 presses both end portions of the recording paper 112 in an arrow G direction, and the recording paper 112 is moved from the cover glass 76.

In this manner, the recording paper 112 is kept apart from the cover glass 76.

The invention is not limited to the above-described exemplary embodiments.

The fixing device 10 may be provided in a horizontal direction and an oblique direction, other than the vertical direction.

The number of the flash lamps 14, 74 and 92 may be other than six.

The number of pipes 22, 24, 44, 46, 48, 54 and 56 may be singular or plural and may be appropriately selected.

The recording paper 112 may be kept apart from the cover glass 16 by using a cam mechanism instead of the solenoid 86.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalent

What is claimed is:

1. A fixing device comprising:
a fixing unit comprising a heat source for fixing a toner image on a sheet in a state of being out of contact with the sheet; and
a contact prevention unit preventing contact of the fixing unit and the sheet.

2. The fixing device of claim 1, wherein the contact prevention unit comprises an air sending part sending air in a direction from the fixing unit toward the sheet to keep the sheet away from the fixing unit.

3. The fixing device of claim 1, wherein the contact prevention unit comprises an air intake part arranged at a position opposed to the fixing unit and intaking air to keep the sheet away from the fixing unit.

4. The fixing device of claim 1, wherein the contact prevention unit comprises an air sending part sending air in a direction from the fixing unit toward the sheet and an air intake part arranged at a position opposed to the fixing unit and intaking air; and the contact prevention unit keeps the sheet away from the fixing unit with the air sending part and the air intake part.

5. The fixing device of claim 1, wherein the contact prevention unit comprises an electrostatic force generation part provided at a position opposed to the fixing unit and keeps the sheet away from the fixing unit by electrostatic attracting force.

6. The fixing device of claim 2, further comprising a reverse air sending part arranged at a position opposed to the fixing unit and sending air in a direction from the sheet toward the fixing unit to put the sheet close to the fixing unit, wherein during fixing, the reverse air sending part sends air to the sheet, and during non-fixing, the operation of the reverse air sending part is stopped and the air sending part sends air to the sheet.

7. The fixing device of claim 1, wherein the fixing unit comprises the heat source and a protective glass for shielding the heat source, and the contact prevention unit prevents contact of the sheet and the protective glass.

8. The fixing device of claim 1, wherein the contact prevention unit comprises a moving part abutting the sheet to keep the sheet away from the fixing unit.

9. A fixing method comprising keeping sheet away from a fixing unit with a contact prevention unit when a sheet jam has occurred.

10. The fixing method according to claim 9, wherein the contact prevention unit comprises an air sending part, and the air sending part sends air toward the sheet to keep the sheet away from the fixing unit.

11. The fixing method according to claim 9, wherein the contact prevention unit comprises an air intake part, and the air intake part intakes air to attract the sheet and keep the sheet away from the fixing unit.

12. The fixing method according to claim 9, wherein the contact prevention unit comprises an air sending part and an air intake part, and the sheet is kept away from the fixing unit by sending air to one surface of the sheet with the air sending part and intaking air to attract the other surface of the sheet with the air intake part.

13. The fixing method according to claim 9, wherein the sheet is moved close to the fixing unit with a reverse air sending part when a sheet jam does not occur, and operation of the reverse air sending part is stopped when a sheet jam occurs.

14. The fixing method according to claim 9, wherein the contact prevention unit comprises an electrostatic force generation part, and the electrostatic force generation part attracts the sheet to keep the sheet away from the fixing unit by electrostatic attracting force.

15. The fixing method according to claim 9, wherein the contact prevention unit comprises a moving part, and the moving part abuts the sheet to keep the sheet away from the fixing unit.
